(19) United States
(12) Patent Application Publication
(10) Pub. No.: US 2015/0096171 A1
(43) Pub. Date: Apr. 9, 2015

(54) METHOD OF INSTALLING GENERATOR WITH AUTOMATIC TRANSFER SWITCH

(71) Applicant: MATTHEW KRAPF, FOGELSVILLE, PA (US)

(72) Inventor: MATTHEW KRAPF, FOGELSVILLE, PA (US)

(21) Appl. No.: 14/050,250

(22) Filed: Oct. 9, 2013

(51) Int. Cl. H02J 9/06; H01H 11/00

(52) U.S. Cl. CPC H02J 9/066; H01H 11/00; H02J 2009/068
USPC 29/825

(57) ABSTRACT

An installation process for a backup generator and ATS which streamlines the ATS and generator installation process and a ATS control box used therewith. In addition to the ATS control box, a two pole circuit breaker, three service relays, and at least one single pole circuit breaker are require to connect to an existing electrical panel. The process entails (1) installing the two pole circuit breaker into the existing electrical panel, (2) connecting the service relays in the electrical panel, (3) connecting breaker relays to any circuit which is not to be fed electricity when utility power is lost, (4) mounting the ATS externally from the electrical panel and connecting it to the above listed components and a electrical panel control feed, and (5) connecting the generator to the ATS control box.

### BACKGROUND OF THE INVENTION

1. Field of the Invention

This invention relates generally to electrical component installation methods and, more particularly, to a streamlined method of installing a backup generator and automatic transfer switch into an existing electrical panel.

2. Description of the Prior Art

The installation and use of backup generators in residential and commercial spaces is well known. In backup generator installations, it is typically desired to include some manner of transfer switch which allows for switching the load between the electric utility power supply and the backup generator and to also isolate the backup generator from the electric utility power network to prevent backfeeding of power when the generator is on and providing temporary power. Because of this, as well as the other aspects of wiring a backup generator into the existing circuitry, installing backup generators is often a difficult, time consuming, and expensive process. The fact that many spaces are constructed in such a way which prevents convenient access to electrical panels and circuit only exacerbates the issues associated with installing a backup generator. For many practical reasons, work around solutions are often required, such as the installation of separate electrical panels for generators to account for an inability to access and connect to the existing panel or an extensive reworking or rewiring existing circuitry. These workarounds, however, often create additional problems, particularly, when the building owner does not want to connect all the circuits in a space to the generator power supply. Thus, there remains a need for a streamlined method of installing a backup generator and automatic transfer switch (“ATS”) which would allow for direct integration with an existing electrical panel even if it is not conveniently located. It would be helpful if such an installation method required minimal additional wiring. It would be additionally desirable for such an installation method to allow for the selection the circuits to receive power when the backup generator is active.

The Applicant's invention described herein provides for a method of installing a backup generator and ATS in residential or commercial spaces. The primary steps of Applicant's installation method involve the installation of relays adapted to switch off selected breakers and the installation of low voltage wiring to actuate the relays when the backup generator turns on. When in operation, the method of installing a backup generator and ATS streamlines the ATS and generator installation process and allows a user to install a generator and ATS into an existing electrical panel, even if the existing panel is located in an area which prevents convenient access thereto. As a result, many of the limitations imposed by standard generator and ATS installation methods are removed.

### SUMMARY OF THE INVENTION

An installation process for a backup generator and ATS which streamlines the ATS and generator installation process and a ATS control box used therewith. The main components required by the process to connect to an existing electrical panel configuration are an ATS control box (ideally built in accordance with the present invention), a two pole circuit breaker, three service relays, and at least one single pole circuit breaker. The process entails (1) installing the two pole circuit breaker into the existing electrical panel for allowing the backfeeding of electricity, (2) connecting the service relays in the electrical panel, with one on each of the main service leads and on the neutral lead, to prevent generator power from backfeeding into utility power during a loss of utility power, (3) connecting breaker relays, which are additionally required if it is desired to switch off certain circuits when back power is used, to any circuit which is not to be fed electricity when utility power is lost, (4) mounting the ATS externally from the electrical panel and connecting it to the above listed components and a electrical panel control feed, and (5) connecting the generator to the ATS control box (if an automatic standby backup generator used; if a portable generator is used, is can be connected when needed).

It is understood that due to the arrangement of the components used, the ATS control box can be disposed in a location relatively far from the electrical panel, which is a substantial distinction from current ATS installations, and still function as desired under normal power, emergency situations when utility power is lost, and during the transition between the two. During normal power, any circuit with a breaker relay installed with function as normal while the 1-120 volt power supply feed to the ATS control box opens a generator feed isolation contactor in the ATS control box so that the utility power cannot backfeed the generator. In an emergency situation, the loss of the 1-120 volt utility power feed to the ATS control box allows the generator feed isolation contactor to close and the generator to be able to backfeed the existing electrical panel. Once the generator is activated, either by automatic operation from a signal from the ATS control box or by manual action, 120 volts provided from the generator to the ATS control panel energizes the 120 volt to 12 volt transformer. Once the transformer is energized, 12 volts are provided to each of the breaker relays and service relays to open the circuits which are not sought to be fed with generator power and disconnect the electrical panel from the utility power source.

It is an object of this invention to provide a streamlined method of installing a backup generator and ATS which would allow for direct integration with an existing electrical panel even if it is not conveniently located.

It is another object of this invention to provide an installation method which requires minimal additional wiring.

It is yet another object of this invention to provide an installation method which still allows for the selection the circuits to receive power when the backup generator is active.

These and other objects will be apparent to one of skill in the art.

### BRIEF DESCRIPTION OF THE DRAWINGS

FIG. 1 shows an installation process in accordance with the present invention.

FIG. 2 is a side elevational view of a circuit breaker and relay switch installation in accordance with the present invention.

FIG. 3 is a top plan view of a circuit breaker and relay switch installation in accordance with the present invention.

FIG. 4 shows a block diagram of the entire system layout for the generator and ATS installation method in accordance with the present invention.

FIG. 5 is a circuit diagram of a ATS in accordance with the present invention.

FIG. 6 is a top plan view of a ATS in accordance with the present invention.

### DETAILED DESCRIPTION OF THE INVENTION

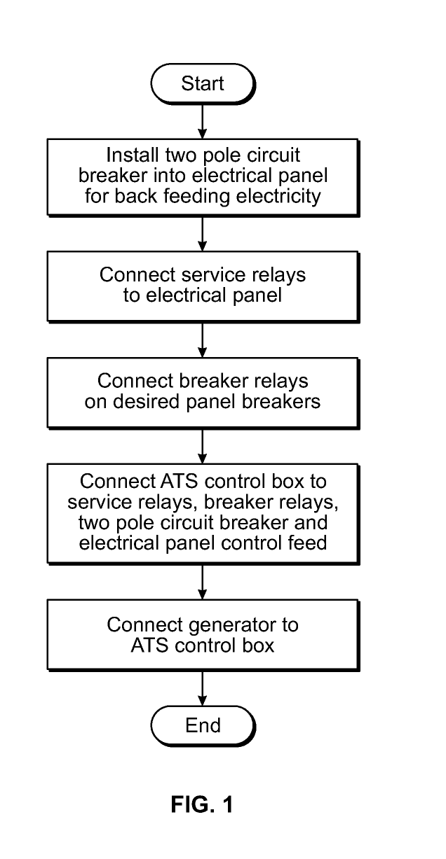

Referring now to the drawings and in particular FIG. 1, the steps of an installation process for a backup generator and ATS in accordance with the present invention is shown. In addition to the existing electrical panel, electrical panel wiring, and utility power components, the process generally requires at least an ATS control box, a generator, a two pole circuit breaker, three service relays, and a single pole circuit breaker. If a user desired to power less than all of the circuits in the electrical panel when the generator was operating, a breaker relay for each breaker sought to be switched off in such circumstances would be additionally required as well as low voltage wire to connect the ATS control box with the breaker relays as well as the service relays.

The three service relays are installed in the electrical panel, on each of the main service leads and on the neutral lead. These service relays are connected to and operated by the ATS control box through 12 volt lines so that, during a loss of utility power, the service relays disconnect the electrical panel from the utility power source so as to prevent generator power from backfeeding into the utility power lines. It is understood that if an ATS control box is a service rated ATS that has contract (load shedding) controls, the three service relays would not be necessary because the service rated ATS would provide the function of the same.

The ATS control box is mounted externally from the electrical panel. In the preferred embodiment, it is disposed inside a weatherproof cabinet so as to allow it to be mountable inside or outside. The ATS control box is electrically connected (1) to receive electrical power from the electrical panel through a 120 volt control feed for controlling the operation of the ATS control box under circumstance when utility power is operational, (2) to receive electrical power from the generator through line voltage wiring, and (3) to feed electrical power (from the generator) to the electrical panel through line voltage wiring. In addition, where breaker relays are provided to switch off circuits in the event that generator electrical power is used, the ATS control box is connected (4) to feed low voltage power to each breaker relay and service relay through low voltage wiring connected to each breaker relay. The ATS control box includes a 120 volt to 12 volt transformer to allow it to provide low power in to said relays when generator power is present. The single pole circuit breaker is included on connection (1), from the electrical panel to the ATS control box, to feed the ATS control box from the electrical panel. The two pole circuit breaker is disposed in the electrical panel, to connect to connection (3) and allow electrical power (from the generator) to backfeed the electrical panel.

Breaker relays are installed where desired on the backside of the existing circuit breakers in the electrical panel. This is done by lifting or taking off the circuit wire from each target circuit breaker, connecting a 12 volt breaker relay to the terminal screw of each target circuit breaker, and connecting the existing circuit wire removed from each respective target circuit breaker and connecting it to the respective 12 volt breaker relay connected to the terminal screw from which the wire was removed. Low voltage wire from the ATS control box is then connected to each installed breaker relay. This configuration allows the ATS control box to open the circuits having breaker relays to shut them off whenever utility power is lost by simply providing a low voltage signal. It is appreciated that because low voltage wiring is used for this function as opposed to line voltage, there are minimal restrictions in how many circuit breakers can be controlled or how far away the circuit breakers to be controlled are. Consequently, the ATS control box is afforded a significant amount of control over the operation of the electrical panel notwithstanding how many circuits are sought to be controlled or how far away the panel is.

During normal power, any circuit with a breaker relay installed with function as normal. The 1-120 volt power supply feeds utility electrical power to the ATS control box, which opens a generator feed isolation contactor so that the utility power cannot backfeed the generator.

During an emergency situation, defined as when utility power is lost, the loss of the 1-120 volt utility power feed to the ATS control box allows the generator feed isolation contactor to close and the generator to be able to backfeed the existing electrical panel. The ATS control panel additionally includes a timer, which causes at least a ten second delay from when utility power is lost before the generator can backfeed the electrical panel. This delay is necessary so as to allow the 120 volts from the generator to the ATS control panel to energize the 120 volt to 12 volt transformer. Once the transformer is energized, 12 volts are provided to each of the breaker relays and service relays to open the circuits which are not sought to be fed with generator power and disconnect the electrical panel from the utility power source.

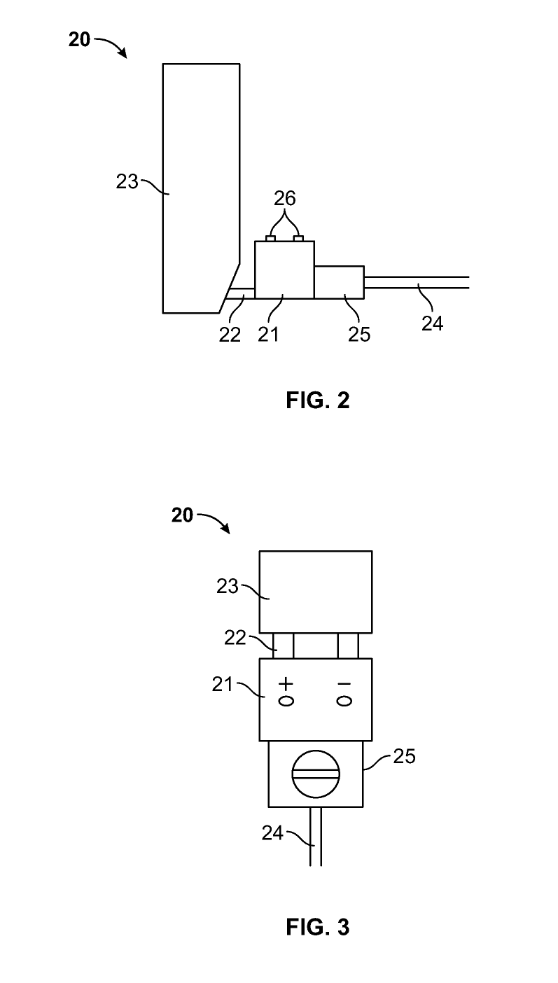

Referring now to FIGS. 2 and 3, the breaker relay assembly 20 includes a 12 volt relay 21, a relay switch connection 22, an existing electrical panel breaker 23, an existing wire 24, and a new termination component 25. The 12 volt relay 21 includes + and − terminals 26, which allow it to receive the connection from the ATS control box (not shown). The relay switch connection 22 goes under the existing breaker wire terminals to connect the 12 volt relay 21 and the terminal screw of the electrical panel breaker 23. The existing wire 24, which was removed from the electrical panel breaker 23, now connects to the new termination component 25, which is connected to the 12 volt relay 21, so that during non emergency situations, electrical power can still pass from the existing wire 24 to the electrical panel breaker 23.

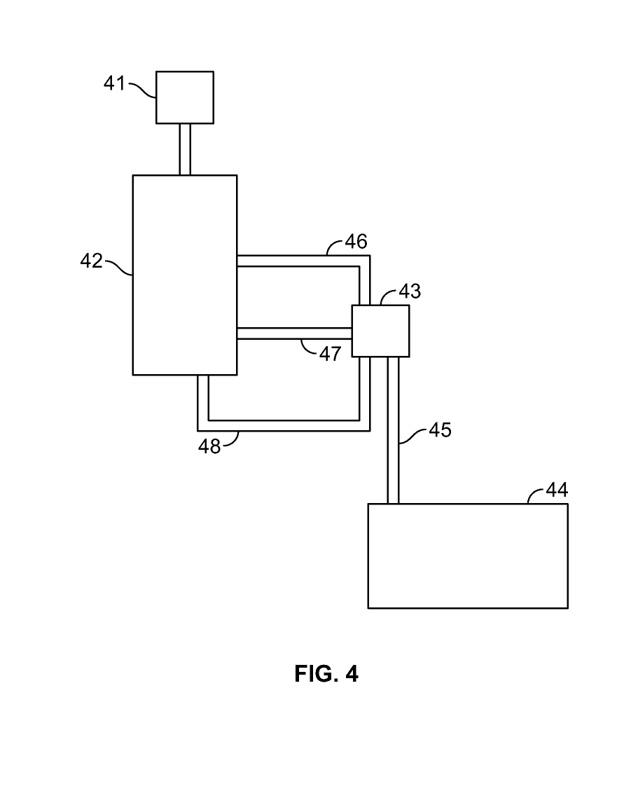

Referring now to FIG. 4, the top level components for the streamlined method of installing a backup generator and automatic transfer switch into an existing electrical panel include an conventional electrical meter 41 and electrical panel 42, a ATS control box 43, and a generator 44. A generator connector 45 links the ATS control box 43 and the generator 44 to allow power to be fed from the generator 44 to the ATS control box 43. A 120 volt control feed 46 allows electrical power for controlling the ATS control box 43 to be fed from the electrical panel 42 to the ATS control box 43. A low voltage conduit 47, housing the low voltage wiring which runs from the ATS control box 43 to the breaker and service relays in place in the electrical panel 42, allows low voltage signals to be sent to said relays in conjunction with the instant installation. A generator feed 48 allows electricity from the generator 44 to be routed from the ATS control box 43 to the electrical panel 42.

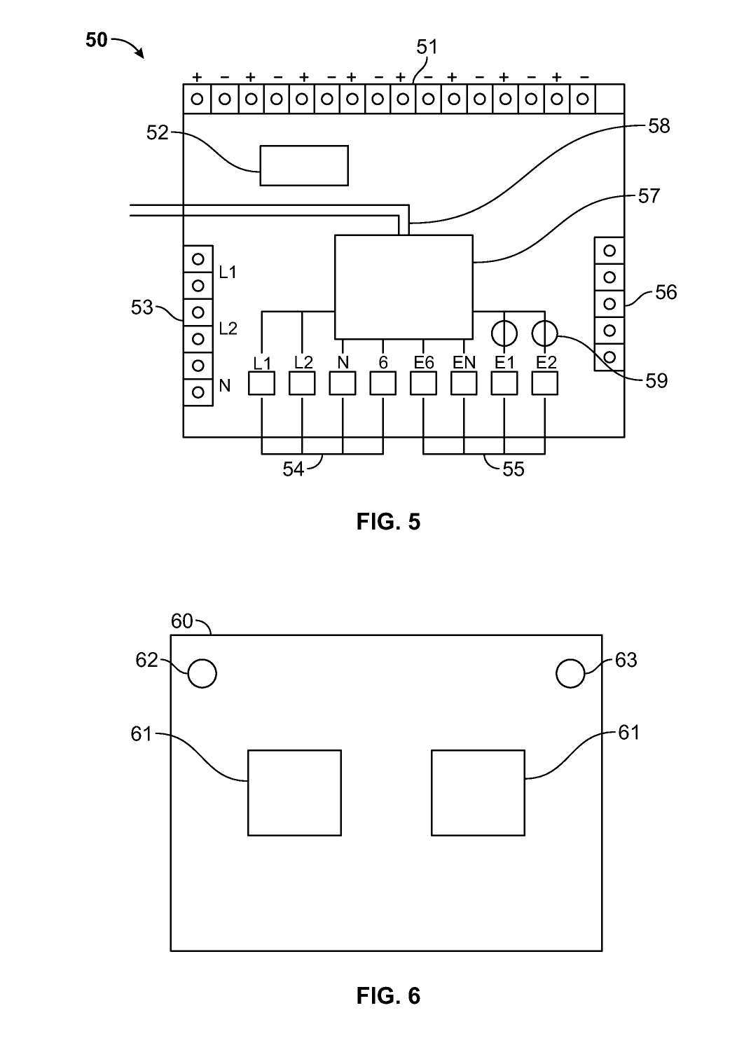

Referring now to FIG. 5, the ATS control box 50 includes a plurality of breaker relay control terminals 51 for connecting to the breaker relays, a 120 volt to 12 volt transformer 52, main service relay terminals 53 for connecting to the service relays, generator feed output terminals 54 for feeding electricity from the generator to be routed from the ATS control box 50 to the electrical panel, generator power input terminals 55 for receiving electricity from the generator, generator control terminals 56 for allowing the ATC control box 50 to start and stop the generator operation, the generator feed isolation contactor 57, the 120 volt control feed 58 (1.5 amp/120 volt to 15 amp/120 volt), and two mini current transformers 59 for measuring the amperage load on the generator. It is contemplated that the ATS control box be rated up to 200 amps.

The ATS control box 50 is adapted to work with and operate an automatic standby backup generator or work with a portable generator. When it is desired for the ATS control box 50 to work with and receive power from a standby backup generator, the standby backup generator is connected to the generator control terminals 56 (in addition to the generator power input terminals 55 through which power is received) so as to form the connection through which the 12 volt signal generated when the ATS control box 50 determines utility power is lost to is transmitted so as to turn on the standby backup generator. When it is desired to connect the ATS control box 50 to a portable generator for receiving electrical power, the ATS control box can simply be connected to the generator power input terminals 55 through which power is received and it is not necessary to connect the generator control terminals 56.

Referring now to FIG. 6, the exterior cover of the ATS control box 60 includes two LED readout screens 61 for displaying the amperage load on the generator, a utility indicator light 62 for indicating the presence of utility power, and a generator indicator light 63 for indicating the presence of generator power. It is contemplated that, as shown in FIG. 5 via the location of the mini current transformers, both of the readout screens 61 are connected to the load side of the generator feed isolation contactor. Electrical data is transmitted to the cover through a cable ribbon connection.

The instant invention has been shown and described herein in what is considered to be the most practical and preferred embodiment. It is recognized, however, that departures may be made therefrom within the scope of the invention and that obvious modifications will occur to a person skilled in the art.

What is claimed is:

1. A streamlined method for installing an automatic transfer switch into an electrical panel, comprising the steps of:
providing an automatic transfer switch at least adapted to receive 120 volt feed and provide at 12 volt signal;
providing at least one breaker relay;
connecting one breaker relay to each circuit in which is desired to not conduct electricity in the absence of utility power;
configuring the automatic transfer switch in a manner which allows it to receive electrical power from the electrical panel when utility power is available to the electrical panel sense the presence of utility power in the electrical panel; and
configuring the automatic transfer switch in a manner which allows the automatic transfer switch to provide a 12 volt signal to each breaker relay when the electrical panel loses utility power.

2. The streamlined method for installing an automatic transfer switch into an electrical panel of claim 1, additionally comprising the step of configuring the automatic transfer switch to provide electrical power to the electrical panel through line voltage wiring.

3. The streamlined method for installing an automatic transfer switch into an electrical panel of claim 2, additionally comprising the steps of:
providing a two pole circuit breaker; and
configuring the two pole circuit breaker in a manner which allows it to allow electricity to be backfed into the electrical panel.

4. The streamlined method for installing an automatic transfer switch into an electrical panel of claim 2, additionally comprising the steps of:
providing at least one service relay; and
configuring the at least one service relay to prevent the electrical power provided to the electrical panel from the automatic transfer switch through line voltage wiring from backfeeding into utility power lines.

5. The streamlined method for installing an automatic transfer switch into an electrical panel of claim 4, wherein:
three service relays are provided; and
one service relay is connected to a first main service lead on the electrical panel, a second main service lead on the electrical panel, and to a neutral lead on the electrical panel.

6. The streamlined method for installing an automatic transfer switch into an electrical panel of claim 2, additionally comprising the steps of:
providing a electric generator; and
configuring the generator to provide electrical power to the automatic transfer switch through line voltage wiring.

7. The streamlined method for installing an automatic transfer switch into an electrical panel of claim 6, wherein said generator is an automatic standby backup generator.

8. The streamlined method for installing an automatic transfer switch into an electrical panel of claim 7, additionally comprising the step of configuring the automatic transfer switch and the generator in a manner which causes the transmission of a 12 volt signal to be transmitted from the automatic transfer switch to the generator when the electrical panel loses utility power.

9. The streamlined method for installing an automatic transfer switch into an electrical panel of claim 1, wherein said automatic transfer switch includes at least one LED readout screens adapted to display the amperage load on the generator.

10. The streamlined method for installing an automatic transfer switch into an electrical panel of claim 1, wherein said automatic transfer switch includes two LED readout screens adapted to display the amperage load on the generator.

11. The streamlined method for installing an automatic transfer switch into an electrical panel of claim 1, wherein said automatic transfer switch includes a utility indicator light adapted to visually indicate the presence of utility power.

12. The streamlined method for installing an automatic transfer switch into an electrical panel of claim 1, wherein said automatic transfer switch includes a generator indicator light adapted to visually indicate the presence of generator power.

13. A streamlined method for installing an automatic transfer switch into an electrical panel, comprising the steps of:
providing an automatic transfer switch at least adapted to receive 120 volt feed and provide at 12 volt signal;
configuring the automatic transfer switch in a manner which allows it to receive electrical power from the electrical panel when utility power is available to the electrical panel sense the presence of utility power in the electrical panel;
providing a electric generator;
configuring the generator to provide electrical power to the automatic transfer switch through line voltage wiring; and
configuring the automatic transfer switch to provide electrical power to the electrical panel through line voltage wiring.

14. The streamlined method for installing an automatic transfer switch into an electrical panel of claim 13, additionally comprising the steps of:
providing a two pole circuit breaker; and
configuring the two pole circuit breaker in a manner which allows it to allow electricity to be backfed into the electrical panel.

15. The streamlined method for installing an automatic transfer switch into an electrical panel of claim 13, additionally comprising the steps of:
providing at least one service relay; and
configuring the at least one service relay to prevent the electrical power provided to the electrical panel from the automatic transfer switch through line voltage wiring from backfeeding into utility power lines.

16. The streamlined method for installing an automatic transfer switch into an electrical panel of claim 15, wherein:
three service relays are provided; and
one service relay is connected to a first main service lead on the electrical panel, a second main service lead on the electrical panel, and to a neutral lead on the electrical panel.

17. The streamlined method for installing an automatic transfer switch into an electrical panel of claim 13, wherein said generator is an automatic standby backup generator.

18. The streamlined method for installing an automatic transfer switch into an electrical panel of claim 17, additionally comprising the step of configuring the automatic transfer switch and the generator in a manner which causes the transmission of a 12 volt signal to be transmitted from the automatic transfer switch to the generator when the electrical panel loses utility power.

19. The streamlined method for installing an automatic transfer switch into an electrical panel of claim 13, wherein said automatic transfer switch includes two LED readout screens adapted to display the amperage load on the generator, a utility indicator light adapted to visually indicate the presence of utility power, and a generator indicator light adapted to visually indicate the presence of generator power.

20. The streamlined method for installing an automatic transfer switch into an electrical panel of claim 13, additionally comprising the steps of:
providing at least one breaker relay;
connecting one breaker relay to each circuit in which is desired to not conduct electricity in the absence of utility power;
configuring the automatic transfer switch in a manner which allows the automatic transfer switch to provide a 12 volt signal to each breaker relay when the electrical panel loses utility power.
